(19) United States
(12) Patent Application Publication
(10) Pub. No.: US 2010/0055309 A1
(43) Pub. Date: Mar. 4, 2010

(54) INTERNAL WELD SEAM PROTECTION FOR CANS

(76) Inventor: Ernst M. Frey, Sigriswil (CH)

Correspondence Address: BIRCH STEWART KOLASCH & BIRCH, PO BOX 747, FALLS CHURCH, VA, 22040-0747, US

(21) Appl. No.: 12/522,865

(22) PCT Filed: Jan. 10, 2008
(86) PCT No.: PCT/CH08/00013

§ 371 Date: Sep. 23, 2009

(30) Foreign Application Priority Data
Jan. 11, 2007 (CH) 31/07

(51) Int. Cl. B05D 7/22; B05C 7/08

(52) U.S. Cl. 427/239; 118/254

(57) ABSTRACT

According to the invention, a continuous protective film (20) made of a thermoplastic material is applied to the internal face (68) of the longitudinal weld seam (16) of sheet metal tubes (10). The sheet metal tubes (10) are fed, when the front sides thereof are practically in contact with one another, via the welding arm (12) of a welding machine and an adjacent application arm (18). The continuously fed thermoplastic material is preheated in the area of the application arm (18), is melted, and is directed to an application device (44) after being homogeneously liquefied, said application device (44) applying the liquid plastic in a metered manner across at least the entire width of the weld seam (16). The preheated thermoplastic material (28) is conducted one way along a first contact surface (63) by means of at least one metallic fusible plug (58) in a liquefaction zone (54) having metal contact and is conducted back the other way along a larger second contact surface (65) after being at least partially liquefied. The application device for the continuous protective film (20) is designed in the form of a doctor blade (82) encompassing a reservoir (84) for the liquefied thermoplastic material and a front comb (86) for doctoring off excess conveyed plastic, said comb (86) extending perpendicular to the direction of travel (26).

The invention relates to a process and devices for applying a continuous protective film of thermoplastic to the inside of the longitudinal weld of sheet metal pipes which are supplied on the end side essentially lying on one another by way of the welding aim of a welding machine and a subsequent application arm, the continuously supplied thermoplastic in the region of the application aim being preheated, melted and after homogeneous liquefaction being routed to an application means, and the liquid plastic being applied proportioned over at least the entire width of the weld.

Welding machines are known which have an application system attached “in-line” for a thermoplastic which applies a protective film to the longitudinal weld of sheet metal pipes, especially bushing and can jackets which have been welded lengthwise. Fundamentally it is differentiated here between application of an enamel and a powder which are processed on site into a layer which covers the weld.

The protective film is applied, depending on the machine type, at the top or bottom, the sheet metal pipe to be treated being transported in the lengthwise direction of the application arm when the protective film is being applied hanging in the upper region on the application arm, for application in the lower region conversely standing on a transport belt.

In particular, for tin cans used in the food industry, a clean, tight, sterilization-resistant inner covering of the weld with an uninterrupted protective film is of the greatest importance. The food purity furthermore dictates that the protective layer will withstand even hard mechanical actions, such as application of crimps or edging. Application of sterilization-resistant “hotmelts”, as thermoplastic cements are abbreviated, has to date also failed due to the fact that they could not be applied with the technical means adapted to conditions and did not withstand the indicated mechanical stresses.

The generic EP 0885085 B1 allows economical, exact application of an inside weld of cans. An application nozzle and a trailing roll are mounted on a pivotable arm, the application nozzle being mounted projecting more than the trailing roll which is used as a spacer by the adjustable thickness of the applied thermoplastic layer. The continuous melting of a supplied plastic wire on the one hand and the configuration of the application nozzle on the other allow an economical process of high quality and great reliability. The strict regulations of the Food Act are also satisfied.

The object of the invention is to devise a process and a device of the initially mentioned type which allows faster and further simplified application to the inside lengthwise weld of sheet metal pipes without increasing the melting point of the thermoplastic and without adversely affecting quality.

With respect to the process, the object is achieved as claimed in the invention in that the preheated thermoplastic in a liquefaction zone with metal contact along the first contact surface is fed through at least one metallic melt insert and after at least partial liquefaction is fed back along the larger second contact surface. Special, developed embodiments of the process are the subject matter of the dependent claims.

The thermoplastic which forms the weld protection must necessarily have good adhesive properties and is therefore also called a “hotmelt”. After cooling, the protective layer of thermoplastic must adhere homogeneously and strongly to the weld, especially also in later process steps and during storage with contents. The thermoplastics can be first of all polyesters which are relatively expensive, but which are resistant and mainly food-safe. For industrial cans which are not food-safe or in special cases even curable epoxy resins can be used.

According to a first embodiment the thermoplastic in the form of a wire is routed by the welding arm into the application arm, first preheated in a preheating zone to a temperature of preferably roughly half the melting point and then in the liquefaction zone with little play fed into the channel of the metallic weld insert which runs in the same direction. The plastic wire pushed with metal contact along a first contact surface into this channel is first solid and then melts continuously. The molten plastic flows at least partially molten into an end-side recess of the melt insert, is rerouted there and then moved again along at least one larger second contact surface, formed by axial channels structured lengthwise, to the inlet side of the plastic wire and is rerouted into the homogenization zone which leads in the direction of the application means. This zone can likewise be heated and is preferably provided with a metallic homogenization insert which advantageously corresponds structurally roughly to the melt insert. Especially preferably the melt and homogenization insert are made in one piece, therefore worked or eroded out of a common, especially cylindrically made metal block.

The channels and the application means are preferably dimensioned and matched to the feed of the plastic filament such that the liquified plastic flows out in a proportionable manner, and pressure cannot build up in the melting apparatus.

The term “wire” also encompasses filaments, cords and the like compared to cross section-long masses.

In the preheating zone the plastic wire is heated for example to 140 to 160° C. and pushed through a sealed opening into the channel of the liquefaction zone where the temperature, depending on the material, is increased to a range of for example roughly 220 to 280° C.

The preheating zone yields among others the advantage that when shut off heat cannot flow back and melt the plastic wire outside the apparatus.

When the welding apparatus is turned on, the preheating zone advantageously remains first cold; it is first turned on roughly 10 minutes after the heating cartridge for liquefaction.

According to another version the thermoplastic can be supplied not only in wire form, but also in another suitable form, for example in powder or granulate form.

Preferably a 10 to 150 micron, especially 20 to 50 micron thick protective film is applied, which depending on the execution of the weld and use of the sheet metal pipes is advantageously 3 to 30 mm wide. According to the configuration of the exit opening the thickness of the protective film is constant over the entire widths or in the middle, directly over the weld where generally increased protection is desired, it is applied somewhat more thickly. Reference is made to text below for the construction of the nozzle opening.

Depending on the thermoplastic of the applied protective film used, sheet metal pipes with an internally coated weld can be routed in-line through a heating zone after coating. In this way the applied protective film is further homogenized. This is especially necessary when an epoxy resin which is comparatively difficult to melt is used, here a longer heating zone than usual is necessary.

The process of EP0885065 B1 can be improved by the more efficient melting process of the thermoplastic. Additional important progress is achieved when instead of an application nozzle a doctor blade with a reservoir for the molten thermoplastic is used. The doctor blade with a horizontal comb which runs perpendicular to the conveyor direction with the reservoir filled to the top with molten thermoplastic is traversed by the sheet metal pipes which are conveyed in the axial direction with the longitudinal weld and which due to adhesion force entrain the liquified plastic in the desired width. The comb of the doctor blade is used as a stripper for excess plastic material. This increases the economic efficiency of the process and the quality.

Another major advantage of using a doctor blade is the greatly increased passage speed of the sheet metal pipes which can be greatly increased without reducing the quality for the protective film. According to current status, with simultaneous application of improved liquefaction and the use of a doctor blade passage speeds up to 90 m/min are possible, optimally they are in the region of 60 to 80 m/min. With application nozzles instead of a doctor blade the optimum passage speeds are roughly 30 to 40 m/min.

With reference to the device, the object is achieved according to one version in that in the liquefaction zone there is a metallic melt insert with at least one heating cartridge, a supply channel which runs in the longitudinal direction for the preheated thermoplastic as a first contact surface, at least one return channel of a larger second contact surface for liquefied thermoplastic, and an end-side communicating recess for rerouting from the supply channel to the return line channels. Special advanced versions of the device are the subject matter of the dependent claims.

Preferably in the homogenization zone there is likewise a metallic homogenization insert through which liquefied thermoplastic has flowed in the application direction and which advantageously corresponds structurally essentially to the melt insert. The melt insert and homogenization insert can be made especially as individual cylindrical elements or running parallel can be worked out of a metallic insert.

Preferably the supply channel of the melt insert is made cylindrical, coaxially to the melt insert itself which is made likewise cylindrical in practice. Much more heat can be supplied to the supplied thermoplastic by the first metallic contact surface of the supply channel and thus the melting temperature can be achieved more quickly. For a thermoplastic which has been introduced in the form of a round wire it has only little play to the first contact surface of the supply channel, thus heat supply can be optimized. When leaving the supply channel the thermoplastic is already at least partially liquified or at least pasty; this enables deflection into the return line channels. In the lengthwise direction they are advantageously partially open against the supply channel and run opening to the outside; this corresponds to the shape of a rosette with reference to cross section.

The geometrical shape of the cross sections of the return line channels is only of secondary importance; it is important that the second contact surface of the metal to the returning liquefied plastic is as large as possible, preferably at least twice as large as the first contact surface of the supply channel.

With reference to heat transfer in the supply channel it has proven advantageous to make it in tapering in the feed direction, with respect to the cross sectional area up to roughly 10%. Thus heat transfer from the metal to the plastic can also optimally take place during the transition from the solid to the liquid form.

According to a second version the object of the invention is achieved with respect to the device in that the application means is made in the form of a doctor blade which has a reservoir for the liquefied thermoplastic and an end-side comb which runs transversely to the device for stripping off the plastic which has been entrained in excess.

A doctor blade allows essentially a much higher passage speed of the sheet metal pipes than an application nozzle. The inner weld surface of the sheet metal pipes is pushed or pulled over the surface of the reservoir of liquid thermoplastic and entrains liquefied plastic by adhesion forces. An excess amount of liquid is stripped off by the doctor blade and retained in the reservoir.

Preferably the comb of the doctor blade in the lengthwise middle region has a recess which corresponds essentially to the width of the weld of the sheet metal pipes. This results in that in the region of the weld a thicker protective film is applied than in the edge region.

A combination of two versions of the device, specifically the formation of a metallic melt body and a doctor blade, is especially advantageous. Thus optimized melting of the thermoplastic and optimum configuration of the application means which are already separately advantageous leads to a combination effect which far exceeds expectations with respect to the application speed and the quality of the protective film.

The invention is detailed using embodiments which are shown in the drawings and which are also the subject matter of dependent claims. The figures are schematic.

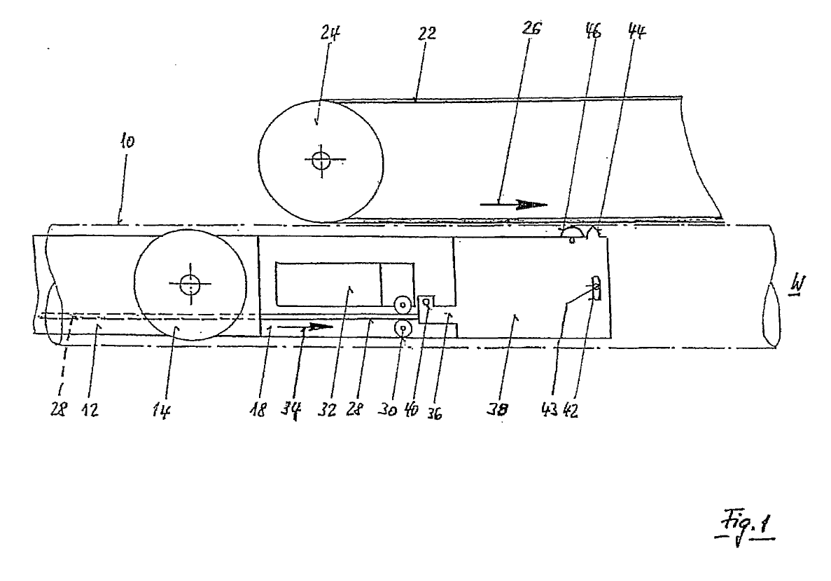

FIG. 1 shows an outline of the region of the welding arm and of the application arm of a melting apparats of a welding machine,

FIG. 2 shows a melting apparatus with a preheating, liquefaction and homogenization zone,

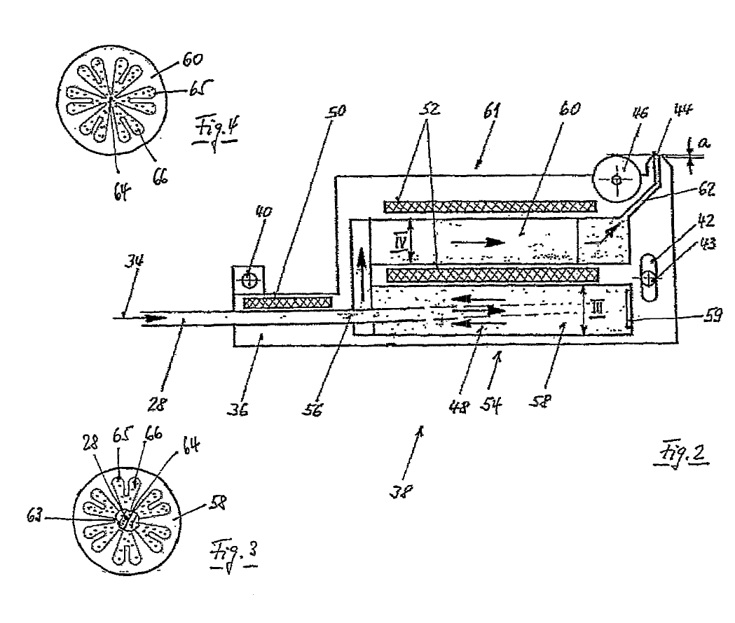

FIG. 3 shows a cross section through a metallic melt insert,

FIG. 4 shows a cross section through a metallic homogenization insert,

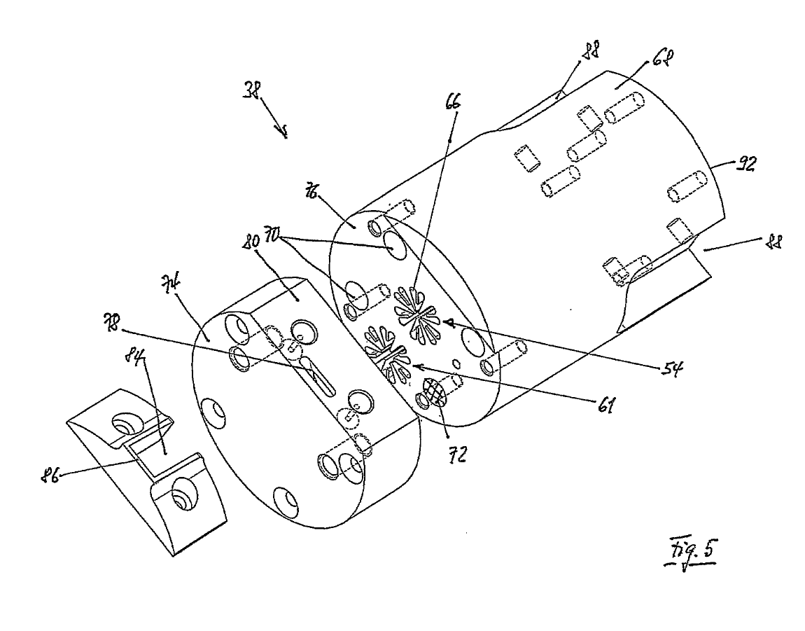

FIG. 5 shows an exploded perspective view of a combined, single-piece melt and homogenization insert with a doctor blade,

FIG. 6 shows a melt insert with an end-side recess,

FIG. 7 shows a perspective view of an insert ready for installation as shown in FIGS. 5 and 6,

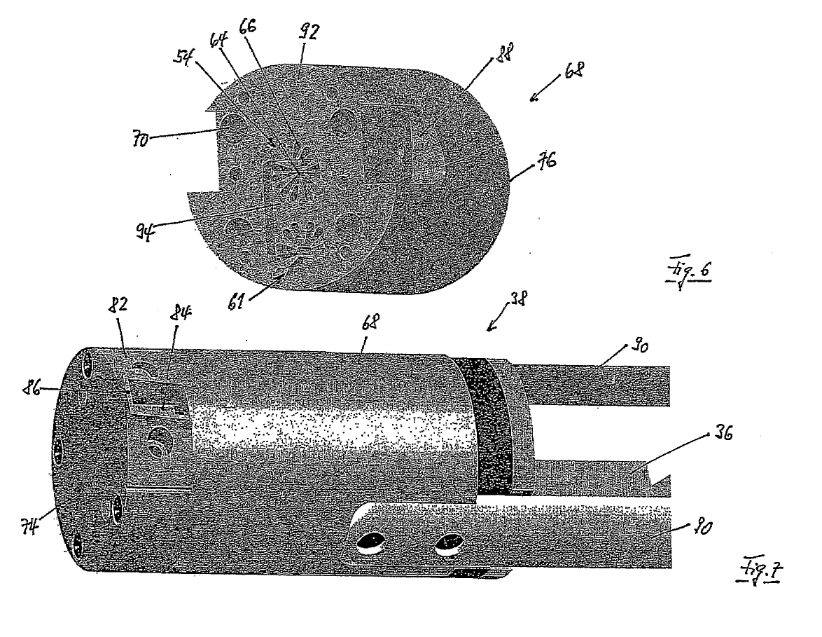

FIG. 8 shows an application nozzle in a front view,

FIG. 9 shows a doctor blade in a front view,

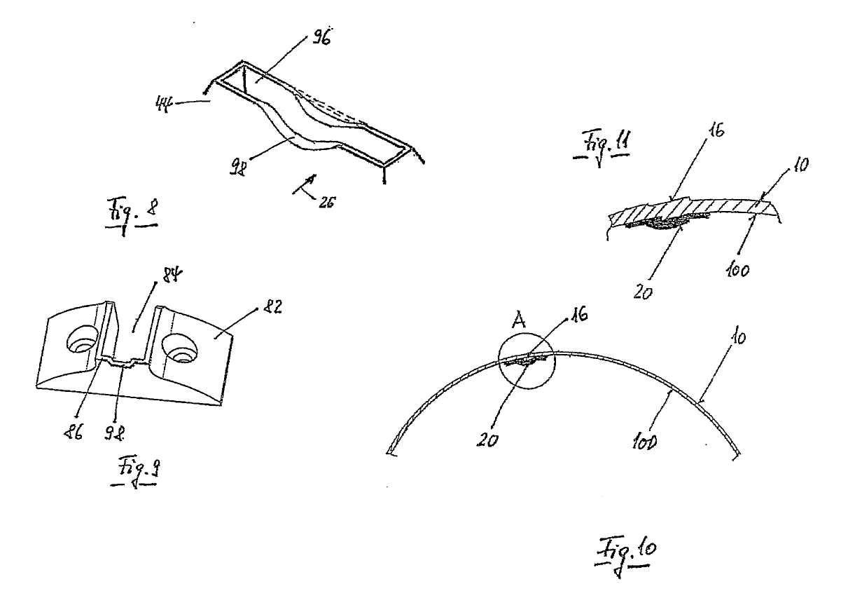

FIG. 10 shows a partial cross section through a sheet metal pipe in the region of the longitudinal weld, and

FIG. 11 shows an enlargement of the region A as shown in FIG. 10.

Of the welding machine for producing sheet metal pipes 10, in FIG. 1 only the welding arm 12 with the welding roll 14 for forming a lengthwise running weld 16 (FIG. 16) of the sheet metal pipes 10 can be recognized. In a coaxial, externally flush extension of the welding arm 12 there is an application arm 18 for a protective film 20 (FIG. 10) on the inside of the weld 16.

On the sheet metal pipes 10, in this case steel pipes, there is an endless transport belt 22 which is tensioned and driven by a deflection roll 24. The sheet metal pipes 10 are transported in the direction of the arrow 26 and are routed through a subsequent heating zone W which is not shown.

A thermoplastic, a so-called hotmelt, wire 28 which is indicated in the region of the welding arm 12 by the broken line runs through a roll pair 30 which is used as a guide and material feed for the plastic wire 28. At least one of the two rolls 30 is driven, here the top roll 30, with an electric motor 32. The plastic wire 28 with a diameter in the region of roughly 2 to 4 mm is pushed in the feed direction indicated by the arrow 34 via preheating 36 into a melting apparatus 38. The melting apparatus 38 can be pivoted as a whole around the suspension 40. A slot 42 which limits this pivoting motion is penetrated by a limiting pin 43 for the melting apparatus 38.

An application nozzle 44 for applying the protective film 20 and a trailing roll 46 as a spacer are attached to the equipment frame of the melting apparatus 38. The melting apparatus 38 is pressed by the means which cannot be recognized in FIG. 1 by way of the trailing roll 46 and the distance a (FIG. 2) of the outflow opening of the application nozzle 44 is kept constant.

FIG. 2 shows the material flow 48 indicated by arrows in the region of the melting apparatus 38 and the inserted heating cartridges 50, 52 in the region of the preheating zone 36, the liquefaction zone 54 and the homogenization zone 60. The plastic wire 28 is heated to roughly 150° C. in the preheating zone 36. The preheated plastic wire 28 enters the melting apparatus 38 through a sealed opening 56 and is pushed through the supply channel 64 (FIG. 3) of a metallic melt insert 58. The farther the plastic wire 28 with metal contact is pushed into the melt insert 58, the more it softens, becomes pasty and finally at least partially liquid. This is indicated by the plastic wire 28 first being shown with longer, then with shorter dashes and finally with dots.

The at least partially liquefied plastic is deflected by the plastic wire 28 which is pushed farther again in a sealed recess 59 which is located on the end side of the melt insert 58 and is returned by the return channels 66 which peripherally surround the supply channel 64 (FIG. 3). This is indicated by the two arrows. Then the liquified mass is deflected again and pushed into an overhead homogenization zone 61 with a metallic homogenization insert 60, where finally extremely homogenous liquefaction of the thermoplastic takes place. Finally, this homogeneously liquefied mass travels by way of an application channel 62 to the application nozzle 44, a wide slot nozzle with an outflow opening which is large with respect to the supply of application material, i.e. the feed of plastic wire 28, and which prevents the pressure from building up in the melting apparatus 38. This outflow opening of the application nozzle 44 is arranged to be shorter by the distance a than the trailing roll 46. Selectively the application nozzle 44 is replaced by a doctor blade 82 which is shown below (FIG. 5).

As shown in claim 2, both the supply channel 64 and also the return channel 66 are heated by external heating cartridges which can also be heating sleeves. Furthermore, according to FIG. 2 the melting apparatus 38 which is located in the application arm 18 can be pivoted. According to embodiments which are not shown, the pivoting axle can also be located in the welding arm 12 (FIG. 1).

FIG. 3 shows a cross section through the melting insert 58 from FIG. 2. The plastic wire 28 which is routed in the supply channel 64 which is coaxial to the melt insert 58 with metal contact is already partially melted or doughy. From the supply channel 64 return channels 66 which run lengthwise in the radial direction extend; compared to an inner pipe of the same diameter they have a surface roughly three times larger and thus due to the increased metal contact have correspondingly increased heat transmission.

The homogenization insert 60 which is shown in FIG. 4 in cross section has channels 64, 66 which run lengthwise, which are comparable to FIG. 3 and which are likewise produced by erosion. The central, lengthwise running channel 64 of the homogenization insert 60 has a much smaller diameter than that of the melt insert 58.

The melting apparatus 38 shown in FIG. 5 shows in an essentially cylindrically made metal block 68 with an eroded liquefaction zone 54 and a homogenization zone 61 [sic]. There is one heating cartridge 72 in each of the four holes 70.

With the metal block 68 there is an essentially disk-shaped head piece 74 which can be screwed onto the end side 76 of the metal block 68, forming a seal. Concealed recesses in the head piece 74 allow backflow of the molten plastic into the backflow channels 66 of the melt insert 58 and transfer of the homogenized liquid plastic mass out of the homogenization zone 61 to the exit slot 78 in the flattened jacket surface 80 of the head piece 74.

A doctor blade 82 can be screwed with its flat side onto this flattened jacket surface 80, forming a seal. This doctor blade 82 has a recess for forming a reservoir 84 of liquified thermoplastic which flows out of the exit slot 78 in a proportionable manner. On the end side, this reservoir 84 is bordered by a comb 86 which runs perpendicular to the conveyor direction and which strips off the excess coating material.

The metal block 68 in the direction of the end side 92 which is not visible has two diagonally opposite recesses 88 for attachment of the holding braces 90 (FIG. 7).

FIG. 6 shows a perspective of the metal block 68 as shown in FIG. 5, viewed in the direction of the other end side 92. A recess 94 which is made on the end side connects the two zones, the rosette-shaped liquefaction zone 54 and the homogenization zone 61. The plastic wire 28 which is not shown is pushed into the central supply channel 64 of the liquefaction zone 54. The liquefied plastic emerges by way of the return channels 66 arranged in a rosette shape on the end side 92. The supply channel 64 and the return channels 66 are connected to one another in communication. The liquefied plastic enters the homogenization zone 61 by way of the recess 94 and is routed to the end side 76.

FIG. 7 shows a melting apparatus 36 which is screwed and attached by way of two retaining braces 90, with preheating 36, a metal block 68 with the liquefaction and homogenization zone which is not visible, and a doctor blade 82 with a reservoir 84 and a comb 86. The aforementioned retaining braces 90 are inserted.

FIG. 8 shows the outflow opening 96 of an application nozzle 44, a wide-slot nozzle. This outflow opening 96 is essentially rectangular lengthwise. The two opposing lengthwise walls of the application nozzle 44 are made recessed in the middle region, in other words the material of the side walls which thicken in the direction pointing away from the outflow opening 96 is removed. This recess 98 results in that when the protective film 20 (FIG. 10) is applied in the middle region of the nozzle much more coating material flows out. In the middle region the protective film 20 is made thicker than in the two edge regions. The recess 98 in the lengthwise-side walls of the nozzle can be in principle of any shape. The reinforcement of the protective film in the middle region is greater, the more material of the side walls is removed.

Also only the long side wall of the application nozzle 44 which lies downstream with respect to feed direction 26 can be removed. The long side wall of the application nozzle 44 which lies upstream remains unchanged in this case; this is indicated by the broken line.

A doctor blade 82 which is shown in FIG. 9 has a comb 86 with a lengthwise-middle recess 98, the actions are the same as shown in FIG. 8, and the middle of the protective film 20 is made thickened.

FIGS. 10, 11 show a sheet metal pipe 10 with a weld 16 which runs lengthwise and which is covered on the inside 100 with a protective film 20.

The lengthwise-running thickening of the protective film 20, which is only roughly 20 microns thick on either side thereof, to roughly 40 microns in the middle region, directly on the weld 16, is easily recognizable. In both side regions therefore less material is applied.

1. Process for applying a continuous protective film (20) of thermoplastic to the inside (68) of a longitudinal weld (16) of sheet metal pipes (10) which are supplied on the end side essentially lying on one another by way of the welding arm (12) of a welding machine and a subsequent application arm (18), the continuously supplied thermoplastic in the region of the application arm (18) being preheated, melted and after homogeneous liquefaction being routed to an application means (44), and the liquid plastic being applied proportioned over at least the entire width of the weld (16), characterized in that
the preheated thermoplastic (28) in a liquefaction zone (54) with metal contact along the first contact surface (63) is routed through at least one metallic melt insert (58) and after the at least partial liquefaction is routed back again along the larger second contact surface (65).

2. Process as claimed in claim 1, wherein the thermoplastic is routed centrally through the melt insert (58) and returned peripherally with at least twice the contact surface (65).

3. Process as claimed in claim 1 or 2, wherein the molten thermoplastic is routed through the metallic homogenization insert (60) to the application means (44, 82).

4. Process as claimed in one of claims 1 to 3, wherein a 10 to 150 micron, especially 20 to 50 micron thick protective film (20) is applied, preferably in the middle, directly to the weld (16) more thickly than in the two side regions.

5. Process as claimed in one of claims 1 to 4, wherein the plastic in the form of a wire (28) in powder or granulate form is routed into the application arm (18), heated in the preheating zone (36) to roughly half the melting point, especially 140 to 160° C., and is pushed through a sealed opening (56) into the melt insert (58).

6. Process as claimed in one of claims 1 to 5, wherein the heating (50) of the preheating zone (36) is turned on time-delayed, preferably roughly 10 minutes after turning on the heating (52) of the melt insert (58) of the liquefaction zone (54) and of the homogenization insert (80).

7. Process as claimed in one of claims 1 to 6, wherein the molten thermoplastic is applied by means of an application nozzle (44) or preferably by means of a doctor blade (82) which borders the reservoir (84).

8. Process as claimed in claim 7, wherein the protective film (20) is applied by way of the doctor blade (82) at a passage speed of the sheet metal pipes (10) up to roughly 90 m/min, preferably 60-80 m/min, the doctor blade (82) stripping excess plastic material entrained by means of adhesion.

9. Device for application of a continuous protective film (20) of thermoplastic to the inside (68) of the lengthwise weld (16) of sheet metal pipes transported in the axial direction in a welding machine with a welding arm (12) and a subsequent application arm (18) which comprises an integrated preheating zone (36), a liquefaction zone (54) and a homogenization zone (61) for the supplied thermoplastic, an application channel (62) and an application means (44) which extends at least over the entire width of the weld (16), wherein
in the liquefaction zone (54) there is a metallic melt insert (58) with at least one heating cartridge (52), a supply channel (64) which runs in the longitudinal direction for the preheated thermoplastic as a first contact surface (63), at least one return channel (66) of a larger second contact surface (65) for liquefied thermoplastic and an end-side communicating recess (59) for rerouting of the plastic melt from the supply channel (64) to the return line channels (66).

10. Device as claimed in claim 9, wherein in the homogenization zone (61) there is a metallic homogenization insert (60) through which liquefied thermoplastic has flowed in the direction of the application means (44, 82) and which essentially corresponds structurally to the melt insert (58).

11. Device as claimed in claim 9 or 10, wherein the supply channel (64) of the melt insert (58) is made cylindrical, in the feed of the thermoplastic in the form of a wire (28) with little play, according to whose diameter the return channels (66) are made increasing in size to the outside in the radial direction, preferably in the form of a rosette, the supply channel (64) being connected also in communication to the return channels.

12. Device as claimed in claim 9 or 10, wherein the supply channel (64) is made cylindrical, in the feed of the thermoplastic in the form of a wire (28) with little play, according to whose diameter, the return channels (66) are arranged in a collar form and at a distance around the supply channel (64).

13. Device as claimed in one of claims 9 to 12, wherein the return channels (66) narrow in the throughflow direction.

14. Device for application of a continuous protective film (20) of thermoplastic to the inside (68) of the lengthwise weld (16) of sheet metal pipes transported in the axial direction in a welding machine with a welding arm (12) and a subsequent application arm (18) which comprises an integrated preheating zone (36), a liquefaction zone (54) and a homogenization zone (61) for the supplied thermoplastic, an application channel (62) and an application means (44) which extends at least over the entire width of the weld (16), wherein
the application means is made in the form of a doctor blade (82) which has a reservoir (84) for the liquified thermoplastic and an end-side comb (86) which runs transversely to the conveyance direction (26) for stripping off the plastic entrained in excess.

15. Device as claimed in claim 14, wherein the comb (86) of the doctor blade (82) in the lengthwise middle region has a recess (98) which corresponds preferably to the width of the weld (16) of the sheet metal pipes (10).
